(19) United States
(12) Patent Application Publication
(10) Pub. No.: US 2024/0037452 A1
(43) Pub. Date: Feb. 1, 2024

(54) LEARNING DEVICE, LEARNING METHOD, AND LEARNING PROGRAM

(71) Applicant: NEC Corporation, Minato-ku, Tokyo (JP)

(72) Inventor: Riki ETO, Tokyo (JP)

(73) Assignee: NEC Corporation, Minato-ku, Tokyo (JP)

(21) Appl. No.: 18/268,664

(22) PCT Filed: Dec. 25, 2020
(86) PCT No.: PCT/JP2020/048791

§ 371 Date: Jun. 21, 2023

(51) Int. Cl. G06N 20/00

(52) U.S. Cl. CPC G06N 20/00

(57) ABSTRACT

A function input means 91 accepts input of a reward function whose features are set to satisfy a Lipschitz continuity condition. An estimation means 92 estimates a trajectory that minimizes Wasserstein distance, which represents distance between probability distribution of a trajectory of an expert and probability distribution of a trajectory determined based on parameters of the reward function. An update means 93 updates the parameters of the reward function to maximize the Wasserstein distance based on the estimated trajectory.

### TECHNICAL FIELD

This invention relates to a learning device, a learning method, and a learning program that performs inverse reinforcement learning.

### BACKGROUND ART

Reinforcement Learning (RL) is known as one of the machine learning methods. Reinforcement Learning is a method to learn behaviors that maximize value through trial and error of various actions. In Reinforcement Learning, a reward function is set to evaluate this value, and the behavior that maximizes this reward function is explored. However, setting the reward function is generally difficult.

Inverse Reinforcement Learning (IRL) is known as a method to facilitate the setting of this reward function. In Inverse Reinforcement Learning, the decision-making history data of an expert is used to generate the reward function that reflects the intention of the expert by repeating optimization using the reward function and updating parameters of the reward function.

Non-Patent Literature (NPL) 1 describes one type of Inverse Reinforcement Learning, Maximum Entropy Inverse Reinforcement Learning (ME-IRL: Maximum Entropy-IRL). The method described in Non-Patent Literature 1 estimates just one reward function R(s, a)=θ·f(s, a) from the expert's data D={τ₁, τ₂, . . . τ_{N}} (where τ=((s₁aᵢ₁), (s₂, a₂), . . . , (s_{N}, a_{N})). This estimated θ can be used to reproduce the decision-making of the expert.

Non-Patent Literature 2 also describes Guided Cost Learning (GCL), a method of Inverse Reinforcement Learning that improves on Maximum Entropy Inverse Reinforcement Learning. The method described in Non-Patent Literature 2 uses weighted sampling to update weights of the reward function.

Also known is imitation learning, which reproduces a given action history by combining Inverse Reinforcement Learning, in which the reward function is learned, with action imitation, in which policies are learned directly (see, for example, Non-Patent Literature 3).

### CITATION LIST

### Non Patent Literature

NPL 1: B. D. Ziebart, A. Maas, J. A. Bagnell, and A. K. Dey, “Maximum entropy inverse reinforcement learning,” In AAAI, AAAI '08, 2008.
NPL 2: Chelsea Finn, Sergey Levine, Pieter Abbeel, “Guided Cost Learning: Deep Inverse Optimal Control via Policy Optimization”, Proceedings of The 33rd International Conference on Machine Learning, PMLR 48, pp. 49-58, 2016.
NPL 3: Jonathan Ho, Stefano Ermon, “Generative adversarial imitation learning”, NIPS '16: Proceedings of the 30th International Conference on Neural Information Processing Systems, pp. 4572-4580, December 2016

### SUMMARY OF INVENTION

### Technical Problem

In Inverse Reinforcement Learning and imitation learning, the reward function is learned so that the difference between the action history of an expert to be reproduced and the optimized execution result is reduced. In Inverse Reinforcement Learning and imitation learning described in Non-Patent Literatures 1-3, the above-mentioned differences are defined in terms of probabilistic distances such as KL (Kullback-Leibler) divergence or JS (Jensen-Shannon) divergence.

Here, the gradient method is generally used to update parameters of the reward function. However, it is difficult to set up probability distributions in combinatorial optimization problems, and it is difficult to apply Inverse Reinforcement Learning as described above to the combinatorial optimization problems, to which many real problems belong.

Therefore, it is an exemplary object of the present invention to provide a learning device, a learning method, and a learning program that can stably perform Inverse Reinforcement Learning in combinatorial optimization problems.

### Solution to Problem

A learning device according to the present invention includes: a function input means which accepts input of a reward function whose features are set to satisfy a Lipschitz continuity condition; an estimation means which estimates a trajectory that minimizes Wasserstein distance, which represents distance between probability distribution of a trajectory of an expert and probability distribution of a trajectory determined based on parameters of the reward function; and an update means which updates the parameters of the reward function to maximize the Wasserstein distance based on the estimated trajectory.

A learning method according to the present invention includes: accepting input of a reward function whose features are set to satisfy a Lipschitz continuity condition; estimating a trajectory that minimizes Wasserstein distance, which represents distance between probability distribution of a trajectory of an expert and probability distribution of a trajectory determined based on parameters of the reward function; and updating the parameters of the reward function to maximize the Wasserstein distance based on the estimated trajectory.

A learning program according to the present invention causes the computer to perform: function input processing of accepting input of a reward function whose features are set to satisfy a Lipschitz continuity condition; estimation processing of estimating a trajectory that minimizes Wasserstein distance, which represents distance between probability distribution of a trajectory of an expert and probability distribution of a trajectory determined based on parameters of the reward function; and update processing of updating the parameters of the reward function to maximize the Wasserstein distance based on the estimated trajectory.

### Advantageous Effects of Invention

According to the present invention, Inverse Reinforcement Learning can be stably performed in combinatorial optimization problems.

### BRIEF DESCRIPTION OF DRAWINGS

FIG. 1 It depicts a block diagram illustrating one exemplary embodiment of a learning device according to the present invention.

FIG. 2 It depicts an explanatory diagram illustrating an example of Inverse Reinforcement Learning using the Wasserstein distance.

FIG. 3 It depicts a flowchart showing an operation example of a learning device.

FIG. 4 It depicts a block diagram showing an overview of a learning device according to the present invention.

FIG. 5 It depicts a schematic block diagram illustrating a configuration of a computer according to at least one exemplary embodiment.

### DESCRIPTION OF EMBODIMENTS

First of all, it is explained why it is difficult to apply general Inverse Reinforcement Learning to combinatorial optimization problems. In ME-IRL described in Non Patent Literature 1, to solve the indefiniteness of the existence of multiple reward functions that reproduce the trajectory (action history) of an expert, the maximum entropy principle is used to specify distribution of trajectories, and the reward function is learned by approaching the true distribution (i.e., maximum likelihood estimation).

In ME-IRL, the trajectory i is represented by Equation 1, illustrated below, and the probability model representing distribution of trajectories p_{θ} (τ) is represented by Equation 2, illustrated below. The c_{θ} (τ) in Equation 2 is a cost function, and reversing the sign (i.e., −c_{θ} (τ)) represents the reward function r_{θ} (τ) (see Equation 3). Also, Z represents the sum of the rewards for all trajectories (see Equation 4).

$$\begin{matrix}[ Math . 1 ] ] & \\ τ = \{ ( {s}_{t} , {a}_{t} ) \vert t = 0 , ⋯ , T \} & ( Equation 1 )\end{matrix}$$

$$\begin{matrix}{p}_{θ} ( τ ) := \frac{1}{Z} exp ( - {c}_{θ} ( τ ) ) \\ where & ( Equation 2 ) \\ - {c}_{θ} ( τ ) = {t}_{θ} ( τ ) = {\sum }_{t = 0}^{T} {γ}^{t} {r}_{θ} ( {s}_{t} , {a}_{t} ) & ( Equation 3 ) \\ Z = {\sum }_{τ} exp ( - {c}_{θ} ( τ ) ) & ( Equation 4 )\end{matrix}$$

The update rule of weights of the reward function by maximum likelihood estimation (specifically, the gradient ascent method) is then represented by Equation 5 and Equation 6, which are illustrated below. α in Equation 5 is the step width, and L_{ME} (θ) is the distance measure between distributions used in ME-IRL.

$$\begin{matrix}[ Math . 2 ] & \\ θ ← θ + α {∇}_{θ} {L}_{ME} ( θ ) & ( Equation 5 )\end{matrix}$$

$${L}_{ME} ( θ ) := \frac{1}{N} {\sum }_{i = 1}^{N} log {p}_{θ} ( τ ) = \frac{1}{N} {\sum }_{i = 1}^{N} ( - {c}_{θ} ( {τ}^{( i )} ) ) - log {\sum }_{τ} exp ( - {c}_{θ} ( τ ) ) \qquad ( Equation 6 )$$

As noted above, the second term in Equation 6 is the sum of the rewards for all trajectories. ME-IRL assumes that the value of this second term can be calculated exactly. However, in reality, it is difficult to calculate the sum of rewards for all trajectories, so the GCL described in Non Patent Literature 2 calculates this value approximately by weighted sampling.

However, because combinatorial optimization problems take discrete values (in other words, values that are not continuous), it is difficult to set up a probability distribution that returns the probability corresponding to a value when a certain value is input. This is because in combinatorial optimization problems, if the value in the objective function changes even slightly, the result may also change significantly.

For example, typical examples of combinatorial optimization problems include routing problems, scheduling problems, cut-and-pack problems, and assignment and matching problems. Specifically, the routing problem is, for example, a transportation routing problem or a traveling salesman problem, and the scheduling problem is, for example, a job store problem or a work schedule problem. The cut-and-pack problem is, for example, a knapsack problem or a bin packing problem, and the assignment and matching problem is, for example, a maximum matching problem or a generalized assignment problem.

The learning device of the present disclosure enables stable Inverse Reinforcement Learning in these combinatorial optimization problems. The exemplary embodiments of the present invention are described below with reference to the drawings.

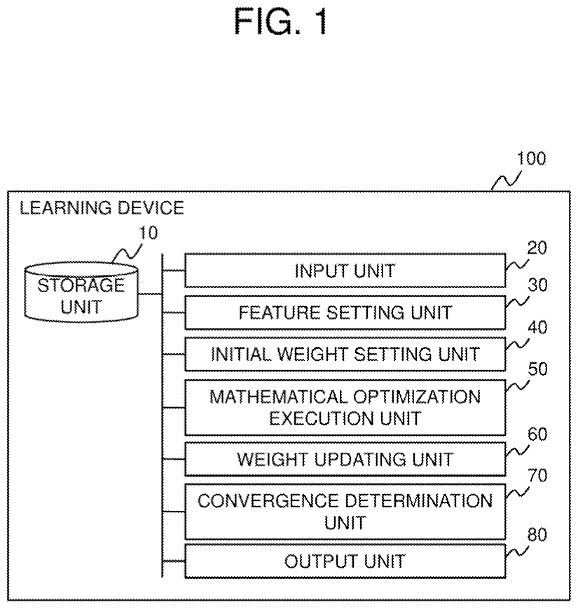

FIG. 1 is a block diagram illustrating one exemplary embodiment of a learning device according to the present invention. The learning device 100 of this exemplary embodiment is a device that performs Inverse Reinforcement Learning to estimate a reward function from the behavior of a subject (expert) through machine learning, and specifically performs information processing based on the behavioral characteristics of an expert. The learning device 100 includes a storage unit 10, an input unit 20, a feature setting unit 30, an initial weight setting unit 40, a mathematical optimization execution unit 50, a weight updating unit 60, a convergence determination unit 70, and an output unit 80.

Since the mathematical optimization execution unit 50, the weight updating unit 60, and the convergence determination unit 70 perform Inverse Reinforcement Learning described below, the device including the mathematical optimization execution unit 50, the weight updating unit 60, and the convergence determination unit 70 can be called an inverse reinforcement learning device.

The storage unit 10 stores information necessary for the learning device 100 to perform various processes. The storage unit 10 may store decision-making history data (trajectory) of an expert that is accepted by the input unit 20, which is described below. The storage unit 10 may also store candidate features of the reward function to be used for learning by the mathematical optimization execution unit 50 and the weight updating unit 60, which will be described later. However, the candidate features need not necessarily be the features used for the objective function.

The storage unit 10 may also store a mathematical optimization solver to realize the mathematical optimization execution unit 50 described below. The content of the mathematical optimization solver is arbitrary and should be determined according to the environment or device in which it is to be executed.

The input unit 20 accepts input of information necessary for the learning device 100 to perform various processes. For example, the input unit 20 may accept input of the expert's decision-making history data (specifically, state and action pairs) described above. The input unit 20 may also accept input of an initial state constraint z to be used by the inverse reinforcement learning device to perform Inverse Reinforcement Learning, as described below.

The feature setting unit 30 sets the features of the reward function from the data including state and action. Specifically, the feature setting unit 30 sets the features of the reward function so that the gradient of the tangent line is finite for the entire function so that the inverse reinforcement learning device described below can use the Wasserstein distance as a distance measure between distributions. The feature setting unit 30 may, for example, set the features of the reward function to satisfy the Lipschitz continuity condition.

For example, let f_{τ} be the feature vector of trajectory τ. If the cost function c_{θ} (τ)=θ^{T}f_{τ} is linearly limited, then if the mapping F: τ→f_{τ} is Lipschitz continuous, then c_{θ} (τ) is also Lipschitz continuous. Therefore, the feature setting unit 30 may set the features so that the reward function is a linear function.

For example, Equation 7, illustrated below, is an inappropriate reward function for this disclosure because the gradient becomes infinite at a₀.

$$\begin{matrix}[ Math . 3 ] & \\ {f}_{τ} = \{ \begin{matrix}1 & ( {a}_{0} \geq 0 ) \\ 0 & ( otherwise )\end{matrix} & ( Equation 7 )\end{matrix}$$

The feature setting unit 30 may, for example, determine a reward function with features set according to user instructions, or may retrieve a reward function that satisfies the Lipschitz continuity condition from the storage unit 10.

The initial weight setting unit 40 initializes weights of the reward function. Specifically, the initial weight setting unit 40 sets the weights of individual features included in the reward function. The method of initializing the weights is not particularly limited, and the weights may be initialized based on any predetermined method according to the user or other factors.

The mathematical optimization execution unit 50 derives a trajectory τ^{\hat{ }} (where τ^{\hat{ }} is the superscript ^{\hat{ }} of τ) that minimizes the distance between the probability distribution of the expert's trajectory (action history) and the probability distribution of the trajectory as determined by the optimized parameters (of the reward function). Specifically, the mathematical optimization execution unit 50 estimates the expert's trajectory τ^{\hat{ }} by using the Wasserstein distance instead of the KL/JS divergence as the distance measure between the distributions and performing a mathematical optimization to minimize the Wasserstein distance.

The Wasserstein distance is defined by Equation 8, illustrated below. Due to restriction of the Wasserstein distance, the cost function c_{θ} (τ) must be a function that satisfies the Lipschitz continuity condition. On the other hand, in this exemplary embodiment, the features of the reward function are set to satisfy the Lipschitz continuity condition by the feature setting unit 30, so the mathematical optimization execution unit 50 can use the Wasserstein distance as described below.

$$\begin{matrix}[ Math . 4 ] & \\ W ( θ ) := \frac{1}{N} {\sum }_{i = 1}^{N} ( - {c}_{θ} ( {τ}^{( i )} ) ) - \frac{1}{N} {\sum }_{i = 1}^{N} ( - {c}_{θ} ( \hat{τ} ( θ , {z}^{( i )} ) ) ) & ( Equation 8 )\end{matrix}$$

The Wasserstein distance defined in Equation 8, illustrated above, takes values less than

or equal to zero, and increasing this value corresponds to bringing the distributions closer together. In the second term of Equation 8, the argument of the cost function c_{θ} (i.e., τ^{\hat{ }} (θ, z⁽ⁱ⁾)) represents the i-th trajectory optimized with the parameter θ. The z is a trajectory parameter. The second term in Equation 8 is a term that can also be calculated in a combinatorial optimization problem. Therefore, by using the Wasserstein distance illustrated in Equation 8 as a distance measure between distributions, Inverse Reinforcement Learning can be stably performed in combinatorial optimization problems.

The weight updating unit 60 updates the parameter θ of the reward function so as to maximize the distance measure between distributions based on the estimated expert's trajectory τ^{\hat{ }}. Specifically, the weight updating unit 60 updates the parameters of the reward function so as to maximize the Wasserstein distance described above. The weight updating unit 60 may, for example, fix the estimated trajectory TA and update the parameters using the gradient ascent method.

In this exemplary embodiment, when updating the parameters of the reward function, the weight updating unit 60 may use the update rule by non-expansive mapping (hereinafter sometimes referred to as the non-expansive mapping gradient method) in order to monotonically increase the Wasserstein distance. The following is a detailed description of the non-expansive mapping gradient method.

Here is an example where a linear function is used as the reward function. If the feature vector of trajectory τ is f_{τ} as described above, the reward function is expressed as in Equation 9, which is illustrated below.

[Math. 5]

−c_{θ}(τ)=r_{θ}(τ)=θ^{T}θ_{T} (Equation 9)

In order to guarantee the monotonically increase nature of the Wasserstein distance, for any given trajectory τₐ and trajectory τ_{b}, as well as the feature vector f_{τa} and feature vector f_{τb} for each trajectory, there must be a constant K that satisfies the relationship illustrated in Equation 10 below.

[Math. 6]

∥θ^{T}ƒ_{τ}_{ₐ}−θ^{T}θ_{τ}_{_{b}}∥≤K∥τₐ−τ_{b}∥ (Equation 10)

Here, Equation 10 illustrated above can be rewritten as Equation 11 shown in the example below.

[Math. 7]

∥ƒ_{τ}_{ₐ}−ƒ_{τ}_{_{b}}∥≤\tilde{K}∥τₐ−τ_{b}∥ (Equation 11)

Let the parameter of the reward function to be updated for the t-th time be θₜ, the Wasserstein distance be W(θₜ), and the step width be at. The update rule for the parameters of the reward function can be expressed as in Equation 12, which is illustrated below.

[Math. 8]

θₜ₋₁=θₜ+αₜ∇W(θₜ) (Equation 12)

The weight updating unit 60 searches for a step width of the gradient that increases the Wasserstein distance under the constraint that the updating rule of the parameters of the reward function (i.e., θ(t)→θ(t+1)) is a non-expansive mapping, and updates the parameters of the reward function at that step width. Specifically, the weight updating unit 60 updates the parameters of the reward function with a step width αₜ that satisfies the conditions illustrated in Equation 13 and Equation 14 below.

$$\begin{matrix}[ Math . 9 ] & \\ 0 < {α}_{l} \leq {α}_{l - 1} \frac{‖ ∇ W ( {θ}_{t - 1} ) ‖}{‖ ∇ W ( {θ}_{t} ) ‖} & ( Equation 13 )\end{matrix}$$

$$W ( {θ}_{t + 1} ) > W ( {θ}_{t} ) \qquad ( Equation 14 )$$

Equation 13 and Equation 14 indicate, since the Wasserstein distance after parameter update is larger (W(θₜ₊₁)>W(θₜ), searching for a value of positive step width a t that is less than or equal to a product of value of the ratio (∥∇W(θₜ₋₁)∥/∥∇W(θₜ) of the slope ∇W(θₜ) of the Wasserstein distance W(0t) at the current update t to the slope ∇W(θₜ₋₁) of the Wasserstein distance W(θₜ₋₁) at the one previous update t−1 and the step width αₜ₋₁ at the one previous update t−1.

For example, in the case of a combinatorial optimization problem, the estimation results by the mathematical optimization execution unit 50 may be discontinuous with respect to changes in the reward function. Specifically, in updates that alternate between maximization and minimization of a certain value, the value may oscillate in many cases and take time to converge. On the other hand, in this exemplary embodiment, the mathematical optimization execution unit 50 uses the above-mentioned non-expansive mapping gradient method, which allows the parameters to be updated while guaranteeing the monotonically increase nature of the Wasserstein distance.

Thereafter, the trajectory estimation process by the mathematical optimization execution unit 50 and the parameter update process by the weight updating unit 60 are repeated until the Wasserstein distance is determined to be converged by the convergence determination unit 70 described below.

The convergence determination unit 70 determines whether the distance measure between distributions has converged. Specifically, the convergence determination unit 70 determines whether the Wasserstein distances converges or not. The method of determination is arbitrary. For example, the convergence determination unit 70 may determine that the distance measure between distributions has converged when the absolute value of the Wasserstein distance between the distributions becomes smaller than a predetermined threshold value.

When the convergence determination unit 70 determines that the distance has not converged, the convergence determination unit 70 continues the processing by the mathematical optimization execution unit 50 and the weight updating unit 60. On the other hand, when the convergence determination unit 70 determines that the distance has converged, the convergence determination unit 70 terminates the processing by the mathematical optimization execution unit 50 and the weight updating unit 60.

The output unit 80 outputs the learned reward function.

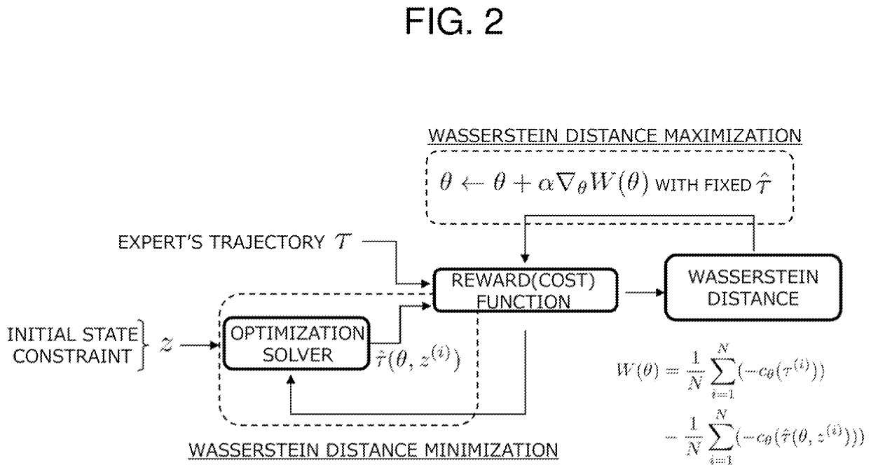

FIG. 2 is an explanatory diagram illustrating an example of Inverse Reinforcement Learning using the Wasserstein distance. The Inverse Reinforcement Learning using Wasserstein distance shown in this disclosure is sometimes referred to as Wasserstein IRL (WIRL).

First, the trajectory τ^{\hat{ }} is estimated by mathematical optimization to minimize the Wasserstein distance using an optimization solver based on the initial state constraints z and the reward function for the parameter θ with initial values. The optimization solver illustrated in FIG. 2 corresponds to the mathematical optimization execution unit 50.

On the other hand, the parameters of the reward function (cost function) are updated by mathematical optimization to maximize the Wasserstein distance based on the estimated trajectory τ^{\hat{ }} and the input expert's trajectory T. This process corresponds to the process of the weight updating unit 60.

Thereafter, the process illustrated in FIG. 2 is repeated until the Wasserstein distance is determined to have converged.

The input unit 20, the feature setting unit 30, the initial weight setting unit 40, the mathematical optimization execution unit 50, the weight updating unit 60, the convergence determination unit 70, and the output unit 80 are implemented by a processor (for example, a central processing unit (CPU)) of a computer that operates according to a program (learning program).

For example, the program may be stored in a storage unit 10 included in the learning device 100, and the processor may read the program and operate as the input unit 20, the feature setting unit 30, the initial weight setting unit 40, the mathematical optimization execution unit the weight updating unit 60, the convergence determination unit 70, and the output unit 80 according to the program. Furthermore, the function of the learning device 100 may be provided in a software as a service (SaaS) format.

In addition, each of the input unit 20, the feature setting unit 30, the initial weight setting unit 40, the mathematical optimization execution unit 50, the weight updating unit 60, the convergence determination unit 70, and the output unit 80 may be implemented by dedicated hardware. In addition, some or all of the components of each device may be implemented by a general-purpose or dedicated circuitry, a processor, or the like, or a combination thereof. These may be implemented by a single chip or may be implemented by a plurality of chips connected via a bus. Some or all of the components of each device may be implemented by a combination of the above-described circuitry or the like and the program.

Furthermore, in a case where some or all of the components of the learning device 100 are implemented by a plurality of information processing devices, circuitries, and the like, the plurality of information processing devices, circuitries, and the like may be arranged in a centralized manner or in a distributed manner. For example, the information processing device, the circuitry, and the like may be implemented as a form in which each of a client server system, a cloud computing system, and the like is connected via a communication network.

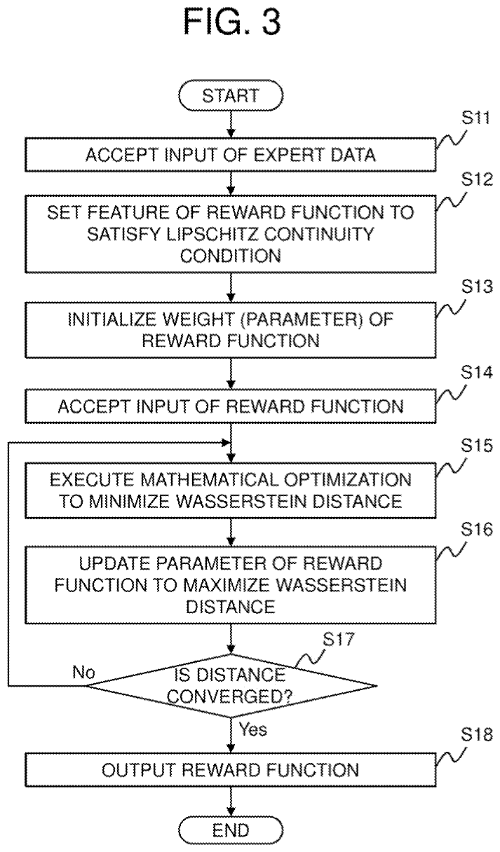

Next, the operation of the learning device 100 in this exemplary embodiment will be described. FIG. 3 is a flowchart showing an operation example of a learning device 100 in this exemplary embodiment. The input unit 20 accepts input of expert data (i.e., trajectory of a expert/decision-making history data) (step S11). The feature setting unit 30 sets features of a reward function from the data including state and action to satisfy Lipschitz continuity condition (step S12). The initial weight setting unit 40 initializes weights (parameters) of the reward function (step S13).

The mathematical optimization execution unit 50 accepts input of a reward function whose features are set to satisfy the Lipschitz continuity condition (step S14). Then, the mathematical optimization execution unit 50 executes mathematical optimization to minimize Wasserstein distance (step S15). Specifically, the mathematical optimization execution unit 50 estimates a trajectory that minimizes the Wasserstein distance, which represents distance between probability distribution of a trajectory of an expert and the probability distribution of a trajectory determined based on the parameters of the reward function.

The weight updating unit 60 updates the parameters of the reward function to maximize the Wasserstein distance based on the estimated trajectory (step S16). The weight updating unit may, for example, update the parameters of the reward function using the non-expansive mapping gradient method.

The convergence determination unit 70 determines whether the Wasserstein distance has converged or not (Step S17). If it is determined that the Wasserstein distance has not converged (No in step S17), the process from step S15 is repeated using the updated trajectory. On the other hand, if it is determined that the Wasserstein distance has converged (Yes in step S17), the output unit 80 outputs the learned reward function (step S18).

As described above, in this exemplary embodiment, the mathematical optimization execution unit 50 accepts input of a reward function whose features are set to satisfy the Lipschitz continuity condition and minimizes the Wasserstein distance, which represents distance between probability distribution of a trajectory of an expert and probability distribution of a trajectory determined based on parameters of the reward function. The weight updating unit 60 then updates the parameters of the reward function to maximize the Wasserstein distance based on the estimated trajectory. Thus, Inverse Reinforcement Learning can be stably performed in combinatorial optimization problems.

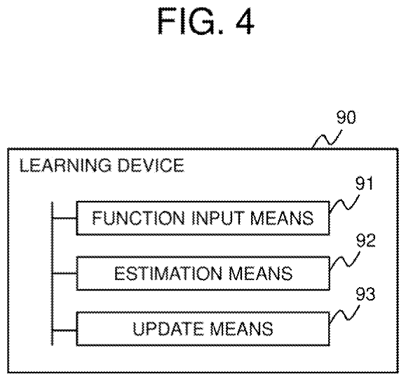

Next, an outline of the present invention will be described. FIG. 4 is a block diagram showing an overview of a learning device according to the present invention. The learning device 90 (e.g., learning device 100) according to the present invention includes a function input means 91 (e.g., mathematical optimization execution unit 50) which accepts input of a reward function whose features are set to satisfy a Lipschitz continuity condition, an estimation means 92 (e.g., mathematical optimization execution unit 50) which estimates a trajectory that minimizes Wasserstein distance, which represents distance between probability distribution of a trajectory of an expert and probability distribution of a trajectory determined based on parameters of the reward function, and an update means 93 (e.g., weight updating unit 60) which updates the parameters of the reward function to maximize the Wasserstein distance based on the estimated trajectory.

With such a configuration, Inverse Reinforcement Learning can be stably performed in combinatorial optimization problems.

The update means 93 may update the parameters of the reward function using a non-expansive mapping gradient method, which is an update rule based on a non-expansive mapping.

Specifically, the update means 93 may update the parameters of the reward function with a step width (e.g., αₜ) less than or equal to a product of a value of a ratio of slope of Wasserstein distance (e.g., ∇W(θₜ)) at this update (t-th) to slope of Wasserstein distance (e.g., ∇W(θₜ₋₁)) at one previous update (t−1-th) and a step width at one previous update (e.g., αₜ₋₁) so that the Wasserstein distance (e.g., W(θ)) after parameter update is larger (e.g., W(θₜ₊₁)>W(θₜ)) (see, for example, Equation 13 and Equation 14).

The learning device 90 may also includes a determination means (e.g., convergence determination unit 70) which determines whether the Wasserstein distance converges or not. Then, in a case where the Wasserstein distance is determined not to be convergent, the estimation means 92 may estimate a trajectory that minimizes Wasserstein distance, which represents distance between probability distribution of a trajectory of an expert and probability distribution of a trajectory determined based on the updated parameters of the reward function, and the update means 93 may update the parameters of the reward function so as to maximize the Wasserstein distance.

The function input means 91 may accept input of a reward function whose features are set to be linear functions.

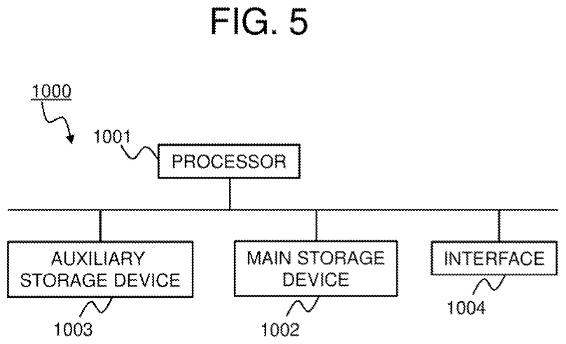

FIG. 5 is a schematic block diagram illustrating a configuration of a computer according to at least one exemplary embodiment. A computer 1000 includes a processor 1001, a main storage device 1002, an auxiliary storage device 1003, and an interface 1004.

The learning device 90 described above is implemented in the computer 1000. Then, the operation of each processing unit described above is stored in the auxiliary storage device 1003 in the form of a program (the learning program). The processor 1001 reads the program from the auxiliary storage device 1003, develops the program in the main storage device 1002, and executes the above processing according to the program.

Note that, in at least one exemplary embodiment, the auxiliary storage device 1003 is an example of a non-transitory tangible medium. Other examples of the non-transitory tangible medium include a magnetic disk, a magneto-optical disk, a compact disc read-only memory (CD-ROM), a digital versatile disk (DVD)-ROM, a semiconductor memory, and the like connected via the interface 1004. Furthermore, in a case where the program is distributed to the computer 1000 via a communication line, the computer 1000 that has received the program may develop the program in the main storage device 1002 and execute the above processing.

Furthermore, the program may be for implementing some of the functions described above. In addition, the program may be a program that implements the above-described functions in combination with another program already stored in the auxiliary storage device 1003, a so-called difference file (difference program).

Some or all of the above exemplary embodiments may be described as the following supplementary notes, but are not limited to the following.

(Supplementary note 1) A learning device comprising:
a function input means which accepts input of a reward function whose features are set to satisfy a Lipschitz continuity condition;
an estimation means which estimates a trajectory that minimizes Wasserstein distance, which represents distance between probability distribution of a trajectory of an expert and probability distribution of a trajectory determined based on parameters of the reward function; and
an update means which updates the parameters of the reward function to maximize the Wasserstein distance based on the estimated trajectory.

(Supplementary note 2) The learning device according to Supplementary note 1, wherein
the update means updates the parameters of the reward function using a non-expansive mapping gradient method, which is an update rule based on a non-expansive mapping.

(Supplementary note 3) The learning device according to Supplementary note 1 or 2, wherein
the update means updates the parameters of the reward function with a step width less than or equal to a product of a value of a ratio of slope of Wasserstein distance at this update to slope of Wasserstein distance at one previous update and a step width at one previous update so that the Wasserstein distance after parameter update is larger.

(Supplementary note 4) The learning device according to any one of Supplementary notes 1 to 3, further comprising
a determination means which determines whether the Wasserstein distance converges or not,
wherein, in a case where the Wasserstein distance is determined not to be convergent, the estimation means estimates a trajectory that minimizes Wasserstein distance, which represents distance between probability distribution of a trajectory of an expert and probability distribution of a trajectory determined based on the updated parameters of the reward function, and the update means updates the parameters of the reward function so as to maximize the Wasserstein distance.

(Supplementary note 5) The learning device according to any one of Supplementary notes 1 to 4, wherein
the function input means accepts input of a reward function whose features are set to be linear functions.

(Supplementary note 6) A learning method comprising:
accepting input of a reward function whose features are set to satisfy a Lipschitz continuity condition;
estimating a trajectory that minimizes Wasserstein distance, which represents distance between probability distribution of a trajectory of an expert and probability distribution of a trajectory determined based on parameters of the reward function; and
updating the parameters of the reward function to maximize the Wasserstein distance based on the estimated trajectory.

(Supplementary note 7) The learning method according to Supplementary note 6, wherein the parameters of the reward function are updates using a non-expansive mapping gradient method, which is an update rule based on a non-expansive mapping.

(Supplementary note 8) A program storage medium storing a learning program causing a computer to perform:
function input processing of accepting input of a reward function whose features are set to satisfy a Lipschitz continuity condition;
estimation processing of estimating a trajectory that minimizes Wasserstein distance, which represents distance between probability distribution of a trajectory of an expert and probability distribution of a trajectory determined based on parameters of the reward function; and
update processing of updating the parameters of the reward function to maximize the Wasserstein distance based on the estimated trajectory.

(Supplementary note 9) The program storage medium storing the learning program according to Supplementary note 8, wherein the parameters of the reward function are updates using a non-expansive mapping gradient method, which is an update rule based on a non-expansive mapping in the update processing.

(Supplementary note 10) A learning program causing a computer to perform:
function input processing of accepting input of a reward function whose features are set to satisfy a Lipschitz continuity condition;
estimation processing of estimating a trajectory that minimizes Wasserstein distance, which represents distance between probability distribution of a trajectory of an expert and probability distribution of a trajectory determined based on parameters of the reward function; and
update processing of updating the parameters of the reward function to maximize the Wasserstein distance based on the estimated trajectory.

(Supplementary note 11) The learning program according to Supplementary note 10, wherein the parameters of the reward function are updates using a non-expansive mapping gradient method, which is an update rule based on a non-expansive mapping in the update processing.

### REFERENCE SIGNS LIST

10 Storage unit
20 Input unit
30 Feature setting unit
40 Initial weight setting unit
50 Mathematical optimization execution unit
60 Weight updating unit
70 Convergence determination unit
100 Learning device

What is claimed is:

1. A learning device comprising:
a memory storing instructions; and
one or more processors configured to execute the instructions to:
accept input of a reward function whose features are set to satisfy a Lipschitz continuity condition;
estimate a trajectory that minimizes Wasserstein distance, which represents distance between probability distribution of a trajectory of an expert and probability distribution of a trajectory determined based on parameters of the reward function; and
update the parameters of the reward function to maximize the Wasserstein distance based on the estimated trajectory.

2. The learning device according to claim 1, wherein the processor is configured to execute the instructions to update the parameters of the reward function using a non-expansive mapping gradient method, which is an update rule based on a non-expansive mapping.

3. The learning device according to claim 1, wherein the processor is configured to execute the instructions to update the parameters of the reward function with a step width less than or equal to a product of a value of a ratio of slope of Wasserstein distance at this update to slope of Wasserstein distance at one previous update and a step width at one previous update so that the Wasserstein distance after parameter update is larger.

4. The learning device according to claim 1, wherein the processor is configured to execute the instructions to:
determine whether the Wasserstein distance converges or not; and
in a case where the Wasserstein distance is determined not to be convergent, estimate a trajectory that minimizes Wasserstein distance, which represents distance between probability distribution of a trajectory of an expert and probability distribution of a trajectory determined based on the updated parameters of the reward function, and update the parameters of the reward function so as to maximize the Wasserstein distance.

5. The learning device according to claim 1, wherein the processor is configured to execute the instructions to accept input of a reward function whose features are set to be linear functions.

6. A learning method comprising:
accepting input of a reward function whose features are set to satisfy a Lipschitz continuity condition;
estimating a trajectory that minimizes Wasserstein distance, which represents distance between probability distribution of a trajectory of an expert and probability distribution of a trajectory determined based on parameters of the reward function; and
updating the parameters of the reward function to maximize the Wasserstein distance based on the estimated trajectory.

7. The learning method according to claim 6, wherein the parameters of the reward function are updates using a non-expansive mapping gradient method, which is an update rule based on a non-expansive mapping.

8. A non-transitory computer readable information recording medium storing a learning program causing a computer to perform:
function input processing of accepting input of a reward function whose features are set to satisfy a Lipschitz continuity condition;
estimation processing of estimating a trajectory that minimizes Wasserstein distance, which represents distance between probability distribution of a trajectory of an expert and probability distribution of a trajectory determined based on parameters of the reward function; and
update processing of updating the parameters of the reward function to maximize the Wasserstein distance based on the estimated trajectory.

9. The non-transitory computer readable information recording medium according to claim 8, wherein the parameters of the reward function are updates using a non-expansive mapping gradient method, which is an update rule based on a non-expansive mapping in the update processing.
